(19) United States
(12) Patent Application Publication
(10) Pub. No.: US 2019/0179624 A1
(43) Pub. Date: Jun. 13, 2019

(54) SOFTWARE UPGRADE IMPACT ANALYSIS BY COGNITIVE SERVICES

(71) Applicant: International Business Machines Corporation, Armonk, NY (US)

(72) Inventors: Pulkit Agarwal, Banaswadi (IN); Santanu Chakrabarty, Bangalore (IN); Sivaranjani Kathirvel, Dharapuram TK (IN); Sivaraj Sethunamasivayam, Bangalore (IN)

(21) Appl. No.: 15/837,238

(22) Filed: Dec. 11, 2017

(51) Int. Cl. G06F 8/65; G06F 9/54

(52) U.S. Cl. CPC G06F 8/65; G06F 9/54

(57) ABSTRACT

A computer-implemented method and system for analyzing a version upgrade to a software application using product documents by: identifying changes made by the version upgrade to an application programming interface (API) used by the software application from the product documents; comparing the identified changes made by the version upgrade to the application programming interface to source code and custom files for the software application, which includes performing natural language processing on the source code and custom files for the software application to analyze components of the source code and custom files that use the application programming interface; and generating an impact analysis report based on the identified changes made by the version upgrade to the application programming interface.

### BACKGROUND

Enterprise software upgrades are essential to keep software applications up-to-date and to provide the new and enhanced features of the upgraded version to the customer. Enterprise software upgrades always involve quite complex steps and require lot of planning and resources. Risks can also appear in number of steps.

Some of the challenges during an upgrade include:
Performance and requirement gaps: Even though the upgrade has enhanced functionality, introducing a new version may cause the software application to malfunction and worsen product performance. For example, if some features are modified in the upgrade, the upgrade may impact any custom functionality in the software application that uses the modified features.
Compatibility issues: Compatibility checks during the upgrade are comprise a critical component of the process. If the upgrade is not compatible with the software application, it may lead to lot of rework.
Technical complexity: Introducing the upgrade may results in some bugs. Additional action is required by a developer to resolve those bugs before and during the upgrade.

As a result, a systematic analysis of the impact of the upgrade is essential for planning a successful upgrade. Such an analysis should be comparatively less expensive than fixing bugs and rewriting the software application after the upgrade.

Thus, there is a need in the art for an impact analysis of an upgrade to identify any potential problems and risks that need to be considered before the upgrade is performed. The present invention satisfies this need.

### SUMMARY

The invention provided herein has a number of embodiments useful, for example, in implementing a computer-implemented method and system for analyzing a version upgrade to a software application using release notes/product documents for the version upgrade.

The method and system identify changes made by the version upgrade to an application programming interface (API) used by the software application from the product documents. Specifically, natural language processing is performed on the product documents to identify the changes made by the version upgrade to the application programming interface used by the software application.

The method and system compare the identified changes made by the version upgrade to the application programming interface to source code for the software application. Specifically, natural language processing is performed on the source code for the software application to analyze components of the source code that use the application programming interface. This also includes the natural language processing performing latent dirichlet allocation on the source code to identify topics in the source code related to the identified changes made by the version upgrade to the application programming interface used by the software application.

The method and system compare the identified changes made by the version upgrade to the application programming interface to the custom files used with the software application, wherein the custom files identify aspects of the software application that have been customized. Specifically, natural language processing is performed on the custom files to analyze components of the custom files that use the application programming interface. This also includes text patterns identified in the product documents being matched against the custom files to identify the custom files that are affected by the identified changes made by the version upgrade to the application programming interface.

The method and system generate an impact analysis report based on the identified changes made by the version upgrade to the application programming interface used by the software application. The impact analysis report may then be used to revise the version upgrade, the source code and the custom files.

### DRAWINGS

Referring now to the drawings in which like reference numbers represent corresponding parts throughout:

FIG. 1 illustrates an embodiment of a cognitive software upgrade analysis system.

FIG. 2 illustrates an exemplary format for content specified in product documents.

FIG. 3 illustrates natural language processing performed to identify existing API changes from the product documents and custom files.

FIG. 4 illustrates natural language processing performed to identify existing API changes from the product documents and source code.

FIG. 5 shows an exemplary impact analysis report generated by the cognitive software upgrade analysis system.

FIG. 6 is a flowchart illustrating the steps performed by the cognitive software upgrade analysis system when implementing the computer-implemented method of this invention, according to one embodiment.

### DETAILED DESCRIPTION

In the following description, reference is made to the accompanying drawings which form a part hereof, and in which is shown by way of illustration one or more specific embodiments in which the invention may be practiced. It is to be understood that other embodiments may be utilized and structural and functional changes may be made without departing from the scope of the present invention.

Overview

The present invention relates to a computer-implemented system for software upgrade impact analysis by cognitive services that analyzes the effects of a version upgrade on at least one software application, using release notes and/or product documents, source code, and custom files, related to the software application being upgraded, and that generates an impact analysis report for the version upgrade. The impact analysis report, which identifies changes made in the version upgrade, is used to plan and/or revise the version upgrade to ensure its success.

System Description

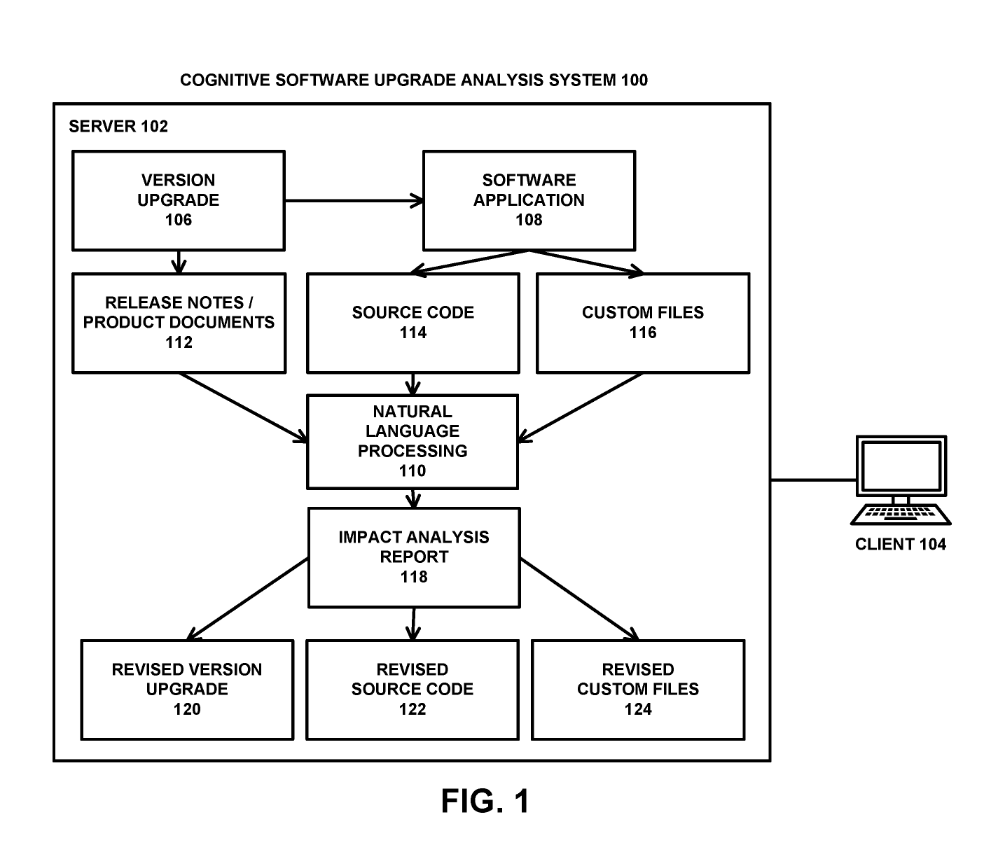

FIG. 1 illustrates an embodiment of a cognitive software upgrade analysis system 100 including one or more server computers 102 that process requests received from one or more client computers 104. Both the server computer 102 and client computer 100 are typically comprised of one or more processors, random access memory (RAM), read-only memory (ROM), and other components such data storage devices and data communications devices. Moreover, both the server computer 102 and client computer 104 execute one or more computer programs operating under the control of an operating system. These computer programs perform various functions as described in more detail below.

In this embodiment, the server 102 processes a request to analyze a version upgrade 106 to a software application 108 executed by the server 102 (or another computer). The server 102 performs natural language processing 110 that analyzes release notes and/or product documents 112, source code 114, and custom files 116, related to the software application 108, in order to generate an impact analysis report 118 for the version upgrade 106, as described in more detail below. The impact analysis report 118 may then be used to generate a revised version upgrade 120, and optionally, revised source code 122 and revised custom files 124.

The release notes and/or product documents 112, hereinafter referred to simply as product documents 112, may include information about new functionalities, enhancements to existing functionalities, and a list of issues resolved in the version upgrade 106, as well as technical documents describing the software application 108 and version upgrade 106, such as upgraded versions of technical documentation for the software application 108. This information may include changes made by the version upgrade 106 to an application programming interface (API) used by the software application 108.

The source code 114 includes a currently-used version of the source code 114 of the software application 108, which may have been customized by a customer. However, there is generally no need for the source code (or object code) of the version upgrade 106 itself.

The custom files 116 identify aspects of the software application 108 that have been customized from out-of-the-box or off-the-shelf versions of the software application 108. This may include one or more configuration files for the software application 108, which identify preference-based options for the software application 108 and its components that have been specially configured by the customer. The custom files 116 may also be used to prioritize components of the software application 108 per the customer's needs.

The impact analysis report 118 contains information about new functionalities (e.g., the introduction of new APIs), enhancements to existing functionalities (e.g., changes to existing APIs), a list of issues resolved in the version upgrade 106, and other information. The impact analysis report 118 may also contain information about changes that need to be made as a result of the version upgrade 106 to the revised source code 122 and revised custom files 124, as well as the revised version upgrade 120 itself. In addition, the impact analysis report 118 may also contain information about the advantages and risks of using new functionalities or enhancements to existing functionalities.

The natural language processing 110 first performs text parsing on the product documents 112 to identify changes made in the version upgrade 106. The natural language processing 110 then performs natural language understanding to analyze the scope of those changes on the source code 114 and custom files 116.

For example, the natural language processing 110 identifies key programming language (PL) specific terms and/or phrases from the product documents 112 that identify changes made to existing APIs in the version upgrade 106. Then, the natural language processing 110 performs natural language understanding to analyze components of the source code 114 that use the existing APIs. The natural language processing 110 also performs natural language understanding to analyze the custom files 116 to evaluate their dependency on the existing APIs.

Release Notes/Product Documents

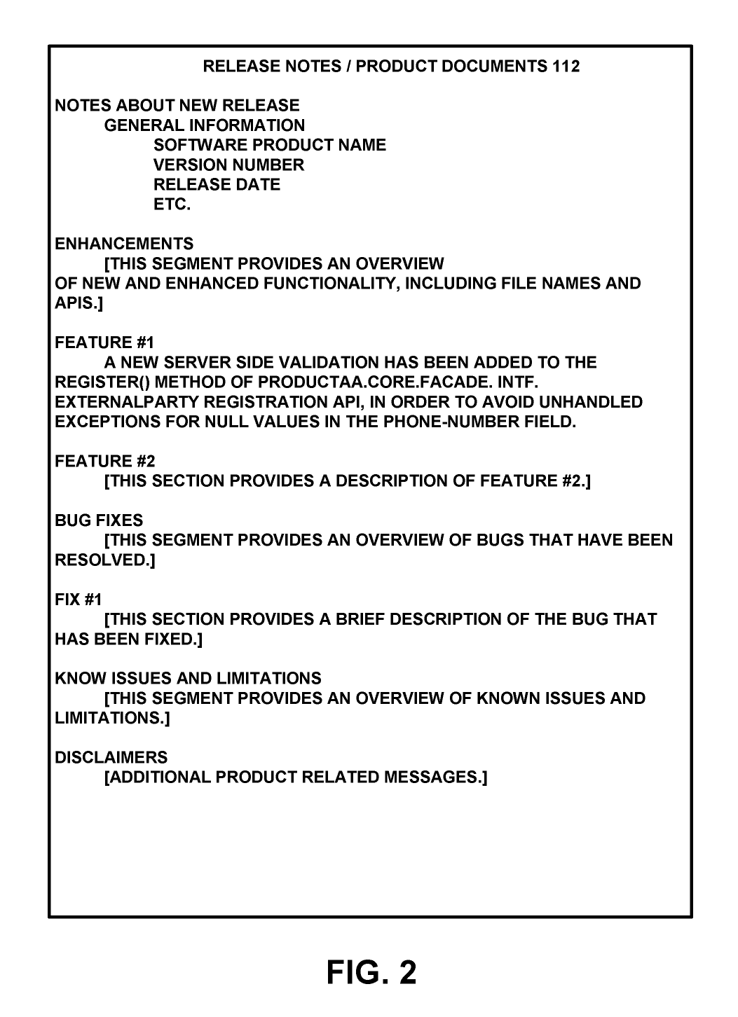

FIG. 2 illustrates an exemplary format for the content specified in the product documents 112. This exemplary format is sufficient for the system 100 to perform the processing described above. This format is a sample template and more elaborate or concise templates can be used by the system 100 to identify relevant terms and associated topics.

In this example, the product documents 112 includes both Segments and Sections within Segments. The Segments are labeled “Notes About New Release”, “Enhancements”, “Bug Fixes”, “Known Issues and Limitations”, and “Disclaimers”. The Sections are labeled “Feature #1” and “Feature #2” in the Segment labeled “Enhancements”, and “Fix #1” in the Segment labeled “Bug Fixes”.

The Segment labeled “Notes About New Release” includes general Information about the new release which includes:
Software Product Name,
Release Number or Version Number,
Release Date, etc.

The Segment labeled “Enhancements” provides an overview of new functionalities and enhancements to existing functionalities. It is recommended that a brief description of the new functionalities and enhancements to existing functionalities be included in this Segment.

The Section labeled “Feature #1” provides a brief description of changes made to Feature #1. In this example, the description comprises the following: “[a] new server side validation has been added to the register( ) method of ProductAA.core.facade.intf.ExternalParty registration API, in order to avoid unhandled exceptions for null values in the Phone-Number field.”

The Section labeled “Feature #2” provides a brief description of changes made to Feature #2.

The Segment labeled “Bug Fixes” provides an overview of “bugs” that have been resolved.

The Section labeled “Fix #1” provides a brief description of a “bug” that has been fixed.

The Segment labeled “Known Issues and Limitations” provides an overview of known issues and limitations, as well as any possible workarounds.

The Segment labeled “Disclaimers” includes additional product related messages.

Processing of Product Documents and Custom Files

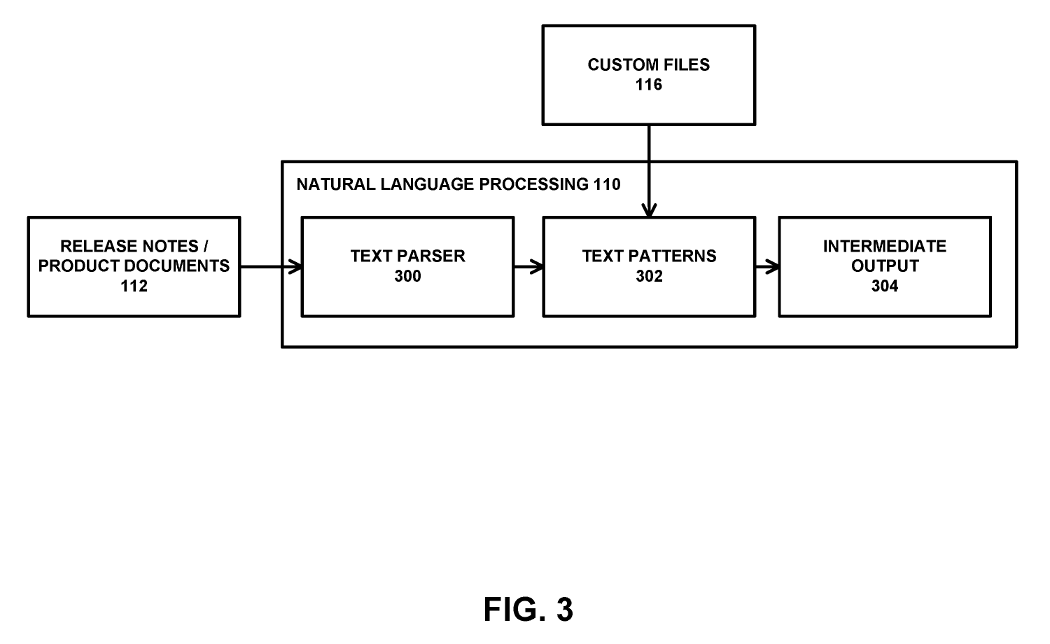

FIG. 3 illustrates the processing performed by the natural language processing 110 in identifying existing API changes from the product documents 112 and the custom files 116.

In this example, a text parser 300 in the natural language processing 110 reads the product documents 112, which includes new and existing API change information. The text parser 300 in the natural language processing 110 uses configurable text parsing techniques to derive text patterns 302 from the unstructured text of the product documents 112. The text patterns 302, which comprises structured text such as file names related to the API change information, are used to filter the list of custom files 116 that are affected by the API change information, to generate an intermediate output 304 comprised of the API change information.

Specifically, the text patterns 302 are matched against the list of custom files 116, and based on the comparison, the custom files 116 that need modification as part of the API change information are grouped in the intermediate output 304. This intermediate output 304 is used by the natural language processing 110 for further processing, as described in more detail below.

Processing of Product Documents and Source Code

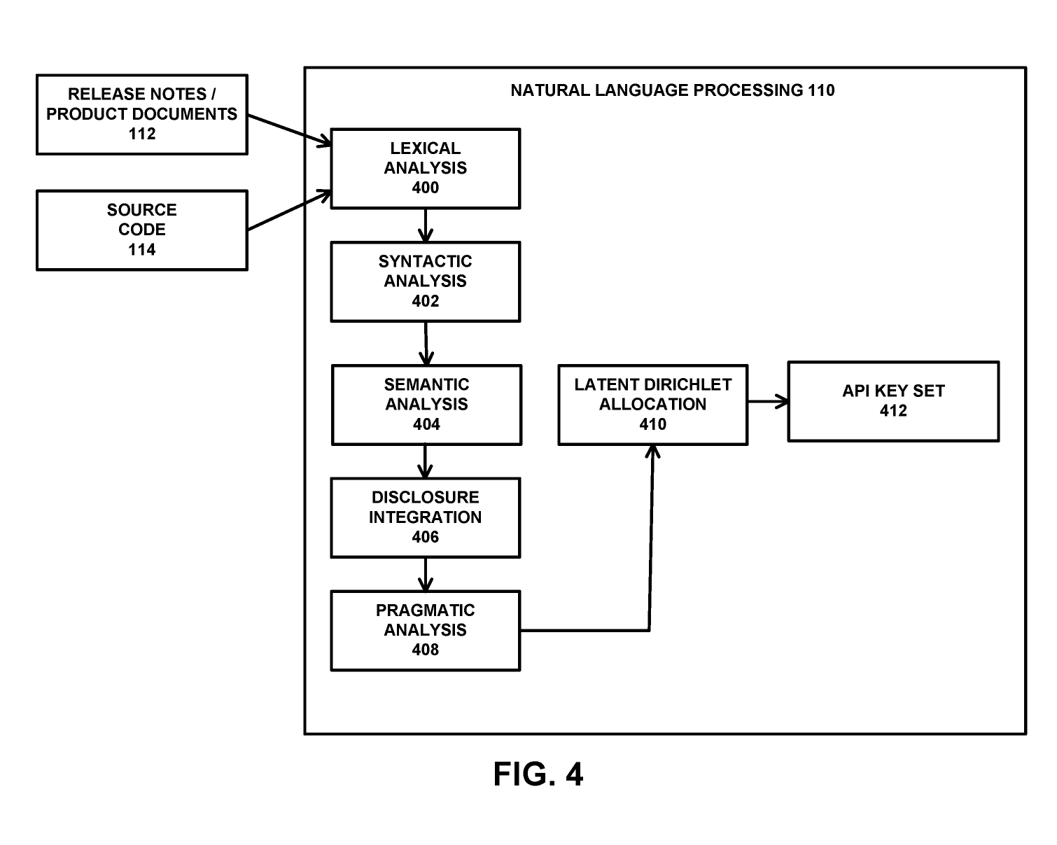

FIG. 4 illustrates the processing performed by the natural language processing 110 in identifying existing API changes from the product documents 112 and the source code 114. The natural language processing 110 performs various processing functions on the product documents 112 and the source code 114, such as lexical analysis 400, syntactic analysis 402, semantic analysis 404, disclosure integration 406, pragmatic analysis 408, and latent dirichlet allocation 410, and then generates an API key set 412.

The natural language processing 110 plays a critical role in analyzing the version upgrade 106, as it performs the actual logic to predict the context of the enhanced functionality from the text data of the product documents 112, and forecasts the risks and benefits of using the enhanced functionality in the source code 114. When predicting the context of the enhanced functionality, and forecasting the risks and benefits of using the enhanced functionality, the natural language processing 110 includes all the existing APIs that have been modified or removed in the version upgrade 106.

The natural language processing 110 processes the product documents 112 to identify the details associated with any existing API changes. The natural language processing 110 parses the text to identify the terms that provide an empirical context for the significance of the existing API changes. The natural language processing 110 also parses the source code 114 for implementation of the existing APIs to understand the context of the programming, including the logical significance for the portions of the source code 114 that use the existing APIs which have been affected by the version upgrade 106.

Specifically, the natural language processing 110 performs the following functions:
Lexical analysis 400 involves identifying and analyzing the structure of terms. A lexicon of a language means the collection of terms in a language. The lexical analysis 402 performs fragmentation of the product documents 112 (e.g., description of changes) and source code 114 (e.g., classes, methods, comments, annotations) into terms.
Syntactic analysis 402 involves the parsing and analysis of the terms for grammar, and arranging of the terms in a manner that shows their relationships.
Semantic analysis 404 draws upon the exact or dictionary meaning from the terms, and the significance of the terms in a programming language lexicon. The terms are checked for meaningfulness, which is performed by mapping syntactic structures and programming language grammar.
Discourse integration 406 derives the meaning of any term, based on the terms before or after that term. In addition, discourse integration 406 also derives the meaning of any term before or after that term.
Pragmatic Analysis 408 re-interprets what was stated by the terms to what is meant by the terms. This involves deriving those aspects of language which require real world knowledge.

The initial set of terms identified above comprise “topics” for the latent dirichlet allocation 410 performed by the natural language processing 110. The latent dirichlet allocation 410 is a statistical model for topic discovery that assumes a document covers a limited set of topics and that the topics are represented by a limited set of frequently used terms. The latent dirichlet allocation 410 is used to generate a logical set of terms from the initial set of terms depending upon the context evaluation for each existing API change. The output of the latent dirichlet allocation 410 is a logical set of terms that bears significance to the existing API changes identified. Specifically, the latent dirichlet allocation 410 assigns a term related to the existing API changes to one or more topics.

To further refine this assignment, the natural language processing 110 performs a repetitive process of analyzing the source code 114, and assigning a term to a topic and computing two things:
1) the proportion of terms in the source code 114 that are currently assigned to the topic; and
2) the proportion of assignments to the topic in the source code 114 that have the same term.

After this process, the natural language processing 110 reaches a state where the assignments can be used to estimate the topics of the source code 114 (by counting the proportion of terms assigned to each topic within the source code 114) and the terms associated with each topic (by counting the proportion of terms assigned to each topic overall).

This refined list of topics is an API key set 412 that provides a meaningful and empirical context for the existing API changes. The API key set 412 contains the context of change as a sequence of key terms, which are then added to the impact analysis report 118 generated by the natural language processing 110.

Training

The natural language processing 110 is initially trained using information that comprises pre-defined sample data sets (e.g., the release notes/product documents 112 related to the current version upgrade 106). Later, the natural language processing 110 is trained using information that comprises previous data sets (e.g., the release notes/product documents 112 related to the previous version upgrades 106), along with optimum real-time working solutions.

The following scenarios of version upgrades 106 may be included in the training:
i. the release notes/product documents 112 for the version upgrade 106, which contain change information on existing APIs;
ii. the release notes/product documents 112 for the version upgrade 106, which contain change information on new APIs, e.g., about new validation added to data attributes to avoid exceptions;
iii. the release notes/product documents 112 for the version upgrade 106, which contain change information on other aspects, e.g., about new columns added to tables to store additional information about records, other database changes, etc.

Based on the initial training, the natural language processing 110 is able to predict the exact context of the version upgrade 106 of the software application 108. Once all the data has been gathered, the natural language processing 110 calculates the effort required for the version upgrade 106 and suggests the order by which components of the software application 108 can be upgraded with the least impact to the current functionality.

Use Case Scenario

Consider the following use case scenario for generating the impact analysis report 118 based on the release notes/product document 112 shown in FIG. 2. This use case represents detailed behavior of the cognitive software upgrade analysis system 100 in all stages, and the corresponding inputs and outputs in each stage.

In a first step, the unstructured text in the product document 112 that recites “[a] new server side validation has been added to the register( ) method of ProductAA.core.facade.intf.ExternalParty registration API, in order to avoid unhandled exceptions for null values in the Phone-Number field” is provided as input to the text parser 300 of the natural language processing 110. In response, the text parses 300 generates the following text patterns 302 “Change_1_Pattern=(Package: ProductAA.core.facade.intf, File Name: ExternalParty, Method: register).” These text patterns 302 are compared to the custom files 116, which include “curam.core.facade.intf.ExternalParty.java”. The comparison results in the intermediate output 304 comprising “Change_1=(Related files: curam.core.facade.intf.ExternalParty.java, . . . )”, wherein “curam.core.facade.intf.ExternalParty.java, . . . ,” represent the custom files 116 that use the existing API identified in the text patterns 302.

In a second step, the natural language processing 110 parses the product document 112, and predicts the key terms related to the context of the existing APIs in the version upgrade 106. Then, the natural language processing 110 also parses the source code 114 for existing APIs and generates the API key set 412 comprised of “K_C1={class: External Party, Method: register, attribute: Phone-Number, Change: New Validation, Custom Changes: null check exists, Data Type Validation, field format validation, Benefit: Avoid unhandled exceptions for null values” that contain the context of the existing API in the source code 114.

The API key set 412 comprises an initial set of terms provided to the latent dirichlet allocation 410. The logical set of terms, after the latent dirichlet allocation 410 is performed, comprises “K_C1={class: External Party, Method: register, attribute: Phone-Number, Change: New Validation, Custom Changes: null check exists, Benefit: Avoid unhandled exceptions for null values”. Similar results would be obtained for other existing APIs.

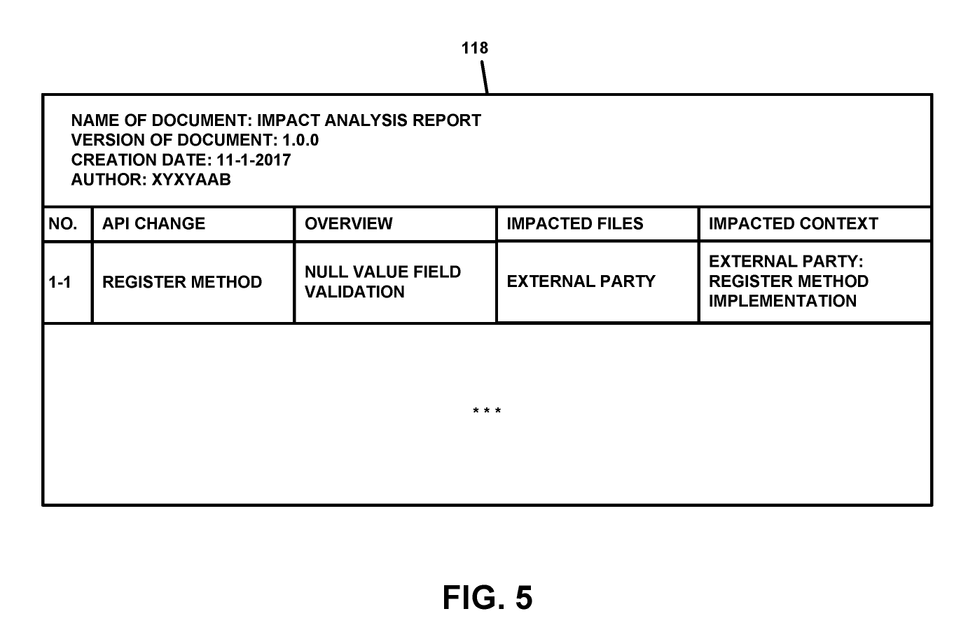

The natural language processing 110 then generates the impact analysis report 118 using the logical set of terms, as shown in FIG. 5. The impact analysis report 118 includes a header reciting “Name of Document: Impact Analysis Report”, “Version of Document: 1.0.0”, “Creation Date: 2016 Nov. 18” and “Author: XYXYAAB”.

The impact analysis report 118 also includes a table with five columns labeled “No.”, “API Change”, “Overview”, “Impacted Files”, and “Impacted Context”, and at least one row with the information (with the column labels in parentheses) including (No.) “1-1”, (API Change) “Register Method”, (Overview) “Empty Field Validation”, (Impacted Files) “External Party”, (Impacted Context) “External Party: Register Method Implementation”.

In this example, the impact analysis report 118 includes details on the changes made to the API “Register Method”, including Empty Field Validation, found in the impacted file External Party, where in the impacted context comprises changes to the register method implementation.

Thereafter, the analysis report 118 may be used to generate a revised version upgrade 120, and optionally, revised source code 122 and revised custom files 124. These revisions may include programming changes that reflect the new field validation performed by the register( ) method

Flowchart

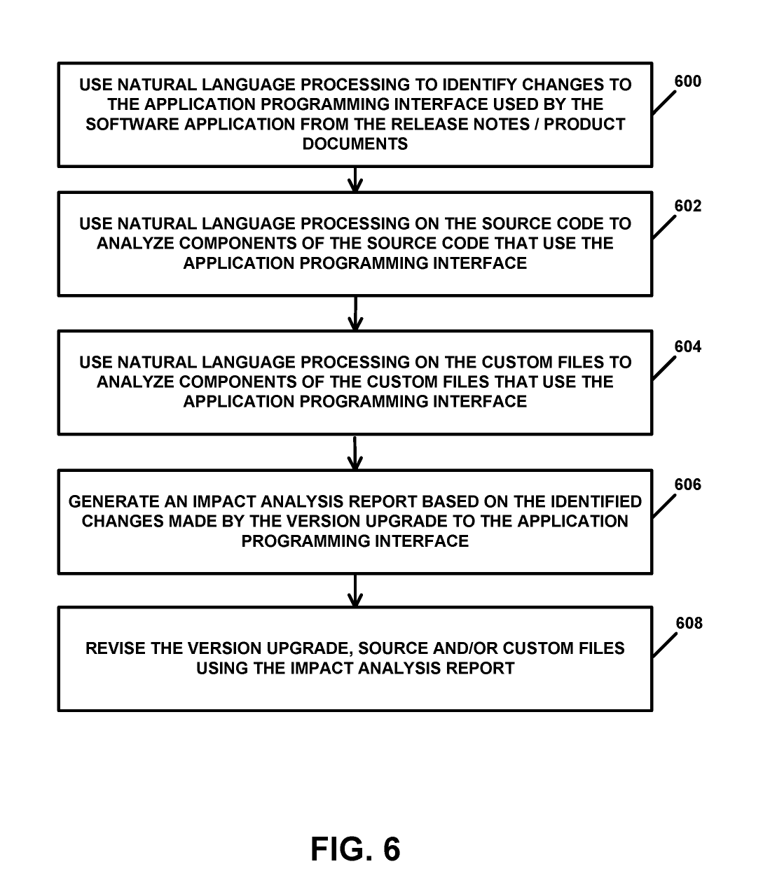

FIG. 6 is a flowchart illustrating the steps performed by the system 100 when implementing the computer-implemented method of this invention, according to one embodiment. Specifically, these steps comprise the system 100 analyzing the version upgrade 106 to the software application 108 using the product documents 112.

Block 600 represents the system 100 identifying changes made by the version upgrade 106 to the application programming interface (API) used by the software application 108 from the product documents 112. Specifically, this step includes natural language processing 110 being performed on the product documents 112 to identify the changes made by the version upgrade 106 to the application programming interface used by the software application 108.

Block 602 represents the system 100 performing natural language processing 110 on the source code 114 to analyze components of the source code 114 that use the application programming interface. This includes comparing the identified changes made by the version upgrade 106 to the application programming interface to the source code 114 for the software application 108. This also includes the natural language processing 110 performing latent dirichlet allocation 410 on the source code 114 to identify topics in the source code 114 related to the identified changes made by the version upgrade 106 to the application programming interface used by the software application 108.

Block 604 represents the system 100 performing natural language processing 110 on the custom files 116 to analyze components of the custom files 116 that use the application programming interface. This includes comparing the identified changes made by the version upgrade 106 to the application programming interface to the custom files 116 used with the software application 108, wherein the custom files 116 identify aspects of the software application 108 that have been customized. This also includes text patterns 302 identified in the product documents 112 being matched against the custom files 116 to identify the custom files 116 that are affected by the identified changes made by the version upgrade 106 to the application programming interface.

Block 606 represents the system 100 generating an impact analysis report 118 based on the identified changes made by the version upgrade 106 to the application programming interface used by the software application 108.

Block 608 represents the system 100 using the impact analysis report 118 to revise the version upgrade 106, the source code 114 and the custom files 116.

Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

### CONCLUSION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
analyzing a version upgrade to a software application using product documents by:
identifying changes made by the version upgrade to an application programming interface (API) used by the software application from the product documents; and
generating an impact analysis report based on the identified changes made by the version upgrade to the application programming interface.

2. The method of claim 1, further comprising using the impact analysis report to revise the version upgrade.

3. The method of claim 1, wherein natural language processing is performed on the product documents to identify the changes made by the version upgrade to the application programming interface.

4. The method of claim 1, further comprising comparing the identified changes made by the version upgrade to the application programming interface to source code for the software application.

5. The method of claim 4, wherein natural language processing is performed on the source code to analyze components of the source code that use the application programming interface.

6. The method of claim 5, wherein the natural language processing performs latent dirichlet allocation on the source code to identify topics in the source code related to the identified changes made by the version upgrade to the application programming interface.

7. The method of claim 4, further comprising using the impact analysis report to revise the source code.

8. The method of claim 1, further comprising comparing the identified changes made by the version upgrade to the application programming interface to custom files used with the software application, wherein the custom files identify aspects of the software application that have been customized.

9. The method of claim 8, wherein natural language processing is performed on the custom files to analyze components of the custom files that use the application programming interface.

10. The method of claim 9, wherein text patterns identified in the product documents are matched against the custom files to identify the custom files that are affected by the identified changes made by the version upgrade to the application programming interface.

11. The method of claim 8, further comprising using the impact analysis report to revise the custom files.

12. A computer-implemented system, comprising:
one or more computers programmed for analyzing a version upgrade to a software application using product documents by:
identifying changes made by the version upgrade to an application programming interface (API) used by the software application from the product documents; and
generating an impact analysis report based on the identified changes made by the version upgrade to the application programming interface.

13. The system of claim 12, further comprising using the impact analysis report to revise the version upgrade.

14. The system of claim 12, wherein natural language processing is performed on the product documents to identify the changes made by the version upgrade to the application programming interface.

15. The system of claim 12, further comprising comparing the identified changes made by the version upgrade to the application programming interface to source code for the software application, wherein natural language processing is performed on the source code to analyze components of the source code that use the application programming interface, and the natural language processing performs latent dirichlet allocation on the source code to identify topics in the source code related to the identified changes made by the version upgrade to the application programming interface.

16. The system of claim 15, further comprising using the impact analysis report to revise the source code.

17. The system of claim 12, further comprising comparing the identified changes made by the version upgrade to the application programming interface to custom files used with the software application, wherein the custom files identify aspects of the software application that have been customized, natural language processing is performed on the custom files to analyze components of the custom files that use the application programming interface.

18. The system of claim 17, wherein text patterns identified in the product documents are matched against the custom files to identify the custom files that are affected by the identified changes made by the version upgrade to the application programming interface.

19. The system of claim 17, further comprising using the impact analysis report to revise the custom files.

20. A computer program product, the computer program product comprising a computer readable storage medium having program instructions embodied therewith, the program instructions executable by one or more computers to cause the computers to perform a method comprising:
analyzing a version upgrade to a software application using product documents by:
identifying changes made by the version upgrade to an application programming interface (API) used by the software application from the product documents; and
generating an impact analysis report based on the identified changes made by the version upgrade to the application programming interface.
